(19) United States
(12) Patent Application Publication
(10) Pub. No.: US 2026/0271086 A1
(43) Pub. Date: Sep. 10, 2026

(54) DYNAMIC INDICATION OF REPETITIONS FOR MSG4

(71) Applicant: Nokia Technologies Oy, Espoo (FI)

(72) Inventors: Alessio MARCONE, Munich (DE); Bo BI, Hangzhou (CN); Frank FREDERIKSEN, Aalborg (DK); Arman AHMADZADEH, Munich (DE)

(21) Appl. No.: 19/471,963

(22) PCT Filed: Apr. 6, 2023
(86) PCT No.: PCT/CN2023/086636

§ 371 Date: Oct. 2, 2025

(51) Int. Cl. H04W 74/0833; H04L 1/1829; H04L 5/00

(52) U.S. Cl. CPC H04W 74/0833; H04L 1/1854; H04L 5/0055

(57) ABSTRACT

Example embodiments of the present disclosure relate to apparatuses, methods, and computer readable storage medium for a dynamic indication of repetitions for Message 4 (Msg4). In the method, an apparatus receives, from a network element, a Downlink Control Information (DCI) message scheduling a Msg4 transmission to the first apparatus during a random access procedure. Then, the apparatus receives, based on the DCI message, a scheduled Msg4 transmission from the network element on a scheduled Physical Downlink Shared Channel (PDSCH) for performing the random access procedure. At least one reserved bit in the DCI message is reused in association with an indication of a repetition factor that is used to transmit at least one Hybrid Automatic Repeat Request Acknowledgement (HARQ-ACK) for the scheduled Msg4 transmission.

### FIELDS

Various example embodiments of the present disclosure generally relate to the field of telecommunication and in particular, to apparatuses, methods, and computer readable storage medium for a dynamic indication of repetitions for Message 4 (Msg4).

### BACKGROUND

In the 3rd generation partnership project (3GPP), it is agreed that physical uplink control channel (PUCCH) for Message 4 (Msg4) hybrid automatic repeat request acknowledgement (HARQ-ACK) needs to be enhanced to meet coverage requirements. It may be desired to support PUCCH repetition for Msg4 HARQ-ACK. For example, one or more repetition factors may be configured via system information block (SIB) for PUCCH for Msg4 HARQ-ACK. However, there is a need for distinction during a random access procedure between user equipment (UEs) with and without PUCCH repetition capability for the Msg4 HARQ-ACK to avoid wrong reception of DCI scheduling Msg4 or PUCCH repetitions for Msg4 HARQ-ACK if the multiple UEs with different capabilities to transmit the same preamble in the same RACH occasion (RO).

### SUMMARY

In a first aspect of the present disclosure, there is provided an apparatus. The apparatus includes at least one processor; and at least one memory storing instructions that, when executed by the at least one processor, cause the apparatus at least to perform: receiving, from a network element, a Downlink Control Information (DCI) message scheduling a Message 4 (Msg4) transmission to the apparatus during a random access procedure; and receiving, based on the DCI message, a scheduled Msg4 transmission from the network element on a scheduled Physical Downlink Shared Channel (PDSCH) for performing the random access procedure, wherein at least one reserved bit in the DCI message is reused in association with an indication of a repetition factor that is used to transmit at least one Hybrid Automatic Repeat Request Acknowledgement (HARQ-ACK) for the scheduled Msg4 transmission.

In a second aspect of the present disclosure, there is provided an apparatus. The apparatus includes at least one processor; and at least one memory storing instructions that, when executed by the at least one processor, cause the apparatus at least to perform: transmitting, to a user device, a Downlink Control Information (DCI) message prior to scheduling a Message 4 (Msg4) transmission towards the user device on a scheduled Physical Downlink Shared Channel (PDSCH); and perform the scheduled Msg4 transmission towards the user device during a random access procedure, wherein at least one reserved bit in the DCI message is reused in association with an indication of a repetition factor to be used by the user device to transmit at least one Hybrid Automatic Repeat Request Acknowledgement (HARQ-ACK) for the scheduled Msg4 transmission.

In a third aspect of the present disclosure, there is provided a method. The method includes: receiving, from a network element, a Downlink Control Information (DCI) message scheduling a Message 4 (Msg4) transmission during a random access procedure; and receiving, based on the DCI message, a scheduled Msg4 transmission from the network element on a scheduled Physical Downlink Shared Channel (PDSCH) for performing the random access procedure, wherein at least one reserved bit in the DCI message is reused in association with an indication of a repetition factor that is used to transmit at least one Hybrid Automatic Repeat Request Acknowledgement (HARQ-ACK) for the scheduled Msg4 transmission.

In a fourth aspect of the present disclosure, there is provided a method. The method includes: transmitting, to a user device, a Downlink Control Information (DCI) message prior to scheduling a Message 4 (Msg4) transmission towards the user device on a scheduled Physical Downlink Shared Channel (PDSCH); and perform the scheduled Msg4 transmission towards the user device during a random access procedure, wherein at least one reserved bit in the DCI message is reused in association with an indication of a repetition factor to be used by the user device to transmit at least one Hybrid Automatic Repeat Request Acknowledgement (HARQ-ACK) for the scheduled Msg4 transmission.

In a fifth aspect of the present disclosure, there is provided a first apparatus. The first apparatus includes means for receiving, from a network element, a Downlink Control Information (DCI) message scheduling a Message 4 (Msg4) transmission to the apparatus during a random access procedure; and means for receiving, based on the DCI message, a scheduled Msg4 transmission from the network element on a scheduled Physical Downlink Shared Channel (PDSCH) for performing the random access procedure, wherein at least one reserved bit in the DCI message is reused in association with an indication of a repetition factor that is used to transmit at least one Hybrid Automatic Repeat Request Acknowledgement (HARQ-ACK) for the scheduled Msg4 transmission.

In a sixth aspect of the present disclosure, there is provided a second apparatus. The second apparatus includes means for transmitting, to a user device, a Downlink Control Information (DCI) message prior to scheduling a Message 4 (Msg4) transmission towards the user device on a scheduled Physical Downlink Shared Channel (PDSCH); and perform the scheduled Msg4 transmission towards the user device during a random access procedure, wherein at least one reserved bit in the DCI message is reused in association with an indication of a repetition factor to be used by the user device to transmit at least one Hybrid Automatic Repeat Request Acknowledgement (HARQ-ACK) for the scheduled Msg4 transmission.

In a seventh aspect of the present disclosure, there is provided a computer readable medium. The computer readable medium includes instructions stored thereon for causing an apparatus to perform at least the method according to the third aspect.

In an eighth aspect of the present disclosure, there is provided a computer readable medium. The computer readable medium includes instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure may become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling diagram of communications between the first and second apparatuses 110 and 120 according to some example embodiments of the present disclosure;

FIG. 3A illustrates a signaling diagram of communications between a UE and a gNB according to some example embodiments of the present disclosure;

FIG. 3B illustrates another signaling diagram of communications between a UE and a gNB according to some example embodiments of the present disclosure;

FIG. 3C illustrates a further signaling diagram of communications between a UE and a gNB according to some example embodiments of the present disclosure;

FIG. 3D illustrates a signaling diagram of communications between a first UE, a second UE and a gNB according to some example embodiments of the present disclosure;

FIG. 4 illustrates a flowchart of a method implemented at a first apparatus according to some example embodiments of the present disclosure;

FIG. 5 illustrates a flowchart of a method implemented at a second apparatus according to some example embodiments of the present disclosure;

FIG. 6 illustrates a simplified block diagram of a device that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements may not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It may not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” or “user device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain may be used as an example of a transmission resource for describing some example embodiments of the present disclosure. It is noted that example embodiments of the present disclosure are equally applicable to other resources in other domains.

The Release 18 (Rel-18) Non-Terrestrial Network (NTN) objectives are focused on the applicability of the solutions developed by general new radio (NR) coverage enhancement to NTN. Moreover, the Rel-18 NTN objectives identify potential issues and enhancements if necessary, considering the NTN characteristics including large propagation delay and satellite movement.

In the 3rd generation partnership project (3GPP), it is concluded that physical uplink control channel (PUCCH) for Message 4 (Msg4) hybrid automatic repeat request acknowledgement (HARQ-ACK) may be enhanced to meet the coverage requirements for parameter set-1 for low earth orbit (LEO)-1200 operating at Line of Sight (LOS), assuming −5 dBi user equipment (UE) antenna gain because the existing design cannot meet the performance requirement with a gap of 1.8 to 6 dB. Later, the expected loss of the UE antenna gain was decreased from −5 dBi to −5.5 dBi, but overall conclusions remain the same.

Furthermore, it is desired that Rel-18 may support PUCCH repetition for Msg4 HARQ-ACK. One or more repetition factors may be configured via system information block (SIB) for PUCCH for Msg4 HARQ-ACK. If multiple factors from {1, 2, 4, 8} are configured via SIB, PUCCH repetition for Msg4 HARQ-ACK may be dynamically determined and indicated by NR node B (also referred to as a NR NB or gNB).

A field in downlink control information (DCI) scheduling the Msg4 physical downlink shared channel (PDSCH) may be used for dynamic indication of repetition factor from gNB. For this purpose, in one example, one or two bits of a modulation and coding scheme (MCS) field may be used. In another example, one or two bits of a PUCCH resource indicator field (e.g., with repetition factor configuration per PUCCH resource) may be used. In a further example, one or two bits of a HARQ process number filed may be used. In yet another example, one or two bits of a downlink assignment index (DAI) field may be used. In still another example, one or two bits of a PDSCH-to-HARQ_feedback timing indicator field may be used. In still another example, a new field with one or two bits may be used.

Alternatively, a field in an Uplink (UL) grant scheduling Message 3 (Msg3) physical uplink shared channel (PUSCH) may be used for dynamic indication of repetition factor from gNB. PUCCH repetition factor is indicated jointly with Msg3 repetition factor by using a pre-defined or configured relationship between PUCCH repetition factor and Msg3 repetition factor.

Alternatively, cyclic redundancy check (CRC) scrambling of DCI scheduling the Msg4 PDSCH may be used for dynamic indication of repetition factor from gNB. For example, one or two CRC bits other than bits scrambled by TC-RNTI may be used for the dynamic indication.

Alternatively, an implicit mapping between Msg4 HARQ ACK repetition factor and Msg3 PUSCH repetition factor with no re-interpreted field or new field (i.e. no change to DCI design) may be used for dynamic indication of repetition factor from gNB.

The following assumption was also reached for the indication of the capability of PUCCH repetitions from the UE to gNB. For PUCCH repetition for Msg4 HARQ-ACK, a physical random access channel (PRACH) preamble and/or occasion may be used as container of the repetition request or capability report indicated by UE. In this case, whether PRACH resource partitioning is needed for indication of repetition request or capability report may be further studied. In addition, whether an indication of repetition factor is assumed or not may be further studied. The relation with REL-18 NR coverage enhancements for PRACH may also need to be considered. Alternatively, a higher layer signaling in Msg3 PUSCH may be used as container of the repetition request or capability report indicated by UE. In this case, which signaling is used may be further studied. Alternatively, a physical layer signaling in Msg3 PUSCH may be used as container of the repetition request or capability report indicated by UE. In this case, which signaling is used (e.g. demodulation reference signal (DMRS) ports) may be further studied.

The latter two alternatives are preferred currently, since an indication of UE capability via PRACH resources would lead to an increased collision probability during PRACH, which would substantially increase the UE access delay especially in an NTN system affected by large round trip times, or require unnecessary additional PRACH resources to be reserved for selected UEs to indicate a potential support of a feature.

In an existing design, the fields of the DCI format 1_0 are defined for the scheduling of the PDSCH. The DCI format 1_0 scrambled by Temporary Cell Radio Network Temporary Identifier (TC-RNTI) scheduling the Msg4 contains a reserved bits field. If the DCI format is monitored in common search space for operation in a cell in frequency range 2-2 and the number of bits for the field of ‘ChannelAccess-CPext’ is 0, the reserved bits field may include 2 bits. Otherwise, these reserved bits field may include 0 bit.

It is observed that: if no distinction is made in PRACH between UEs with and without PUCCH repetition capability for the Msg4 HARQ-ACK, multiple UEs with such different capabilities may transmit the same preamble in the same RACH occasion (RO). In this case, gNB would not be able to distinguish those multiple UEs, which are assigned the same uplink (UL) grant and TC-RNTI for the transmission of the subsequent Msg3. Because of this, the multiple UEs with different capability transmit the Msg3 in the same time-frequency resources scrambling the payload with the same TC-RNTI. However, gNB may only be able to detect the UE among the multiple UEs with the dominant signal, and may transmit the subsequent Msg4 with a contention resolution message addressing such dominant UE. Moreover, the Msg4 is carried in a PDSCH scheduled by a DCI 1_0 with CRC scrambled with the TC-RNTI used by the multiple UEs for transmission of the Msg3. However, since the multiple UEs are not aware of which UE among them was the dominant UE in Msg3 (i.e., each UE of the multiple UEs is not aware of the other UEs of the multiple UEs), they may all try to receive and decode such DCI 1_0 with CRC scrambled by the TC-RNTI carrying scheduling information of the Msg4. This scenario may be referred to as “preamble collision (PC)” hereinafter. This PC often occurs in case of high cell load.

If it is assumed that the dynamic indication of repetition factor from gNB for the UE with PUCCH repetition capability occurs via repurposing of a DCI field, as for example the MCS field, but the dominant Msg3 is from a UE of the multiple UEs without PUCCH repetition capability, then gNB transmits the DCI scheduling the Msg4 (and whose CRC is scrambled with the TC-RNTI) with a non-repurposed MCS field. Otherwise, the DCI may be transmitted with repurposed MCS.

Two subcases of PC will be described in detail below. For a first subcase of PC, in case that gNB transmits the DCI scheduling the Msg4 with a non-repurposed MCS field, a UE with support of this capability may have problems in decoding the Msg4 because it is assuming that the field is repurposed and hence may wrongly interpret the MCS index, and it may send a negative acknowledgement (NACK) to gNB with repetitions in resources that were not assigned for such repetitions, since the MCS field is actually not repurposed. Therefore, interference may be introduced on time-frequency resources not assigned for PUCCH transmission.

For a second subcase of PC, in case that gNB transmits the DCI scheduling the Msg4 with a repurposed MCS, a UE without capability may have problem in decoding the Msg4 due to wrong interpretation of the MCS index and lead to a RACH re-attempt (i.e., restarting of the RACH procedure from the PRACH transmission) after reaching expiration of a contention resolution timer.

Even if the example was carried out with one or two bits of a MCS field, the same ambiguity exists for the other above-mentioned alternatives and in general as long as an existing field in DCI is going to be repurposed.

Example embodiments of the present disclosure propose a scheme for indicating the PUCCH Repetition factor for Msg4 HARQ-ACK. With this scheme, the reserved bits in a DCI message for scheduling a Msg4 transmission is reused in association with an indication of a repetition factor that is used to transmit at least one HARQ-ACK for the scheduled Msg4 transmission.

The proposed scheme may avoid ambiguity towards the PC scenario. For example, in the first PC subcase (non-repurposed field of reserved bits), even UEs with PUCCH repetition capability may be able to correctly interpret the DCI (as the reserved bits may just be set to 0), decode the Msg4 and promptly re-start the RACH procedure without having to wait to the end of the contention resolution window and without transmitting “NACK” with repetitions occupying resources not assigned for the repetitions. In the second PC subcase (repurposed field of reserved bits), even UEs without PUCCH repetition capability may be able to decode the message (as they may ignore the content of the reserved bits field) and promptly re-start the RACH procedure without having to wait to the end of the contention resolution window and improve the RACH performance. Thus, the random access procedure may be more effective and efficient.

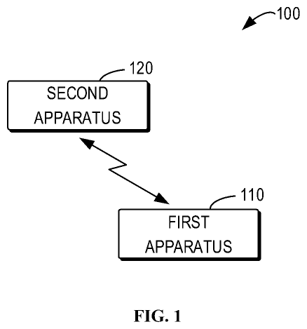

FIG. 1 illustrates an example communication environment 100 in which example embodiments of the present disclosure can be implemented. In the communication environment 100, a first apparatus 110 and a second apparatus 120 can communicate with each other.

In the following, for the purpose of illustration, some example embodiments are described with the first apparatus 110 operating as a terminal device and the second apparatus 120 operating as a network device. However, in some example embodiments, operations described in connection with a terminal device may be implemented at a network device or other device, and operations described in connection with a network device may be implemented at a terminal device or other device.

In some example embodiments, if the first apparatus 110 is a terminal device and the second apparatus 120 is a network device, a link from the second apparatus 120 to the first apparatus 110 is referred to as a downlink (DL), while a link from the first apparatus 110 to the second apparatus 120 is referred to as an uplink (UL). In DL, the second apparatus 120 is a transmitting (TX) device (or a transmitter) and the first apparatus 110 is a receiving (RX) device (or a receiver). In UL, the first apparatus 110 is a TX device (or a transmitter) and the second apparatus 120 is a RX device (or a receiver).

Communications in the communication environment 100 may be implemented according to any proper communication protocol(s), including, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, including but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

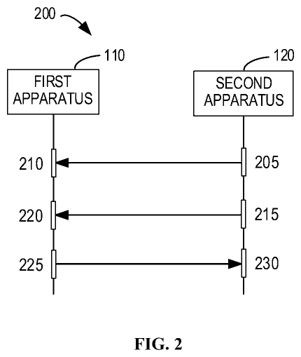

FIG. 2 illustrates a signaling diagram 200 of communications between the first and second apparatuses 110 and 120 according to some example embodiments of the present disclosure. Although one first apparatus 110 and one second apparatus 120 are illustrated in FIG. 2, it would be appreciated that there may be a plurality of first apparatuses performing similar operations as described with respect to the first apparatus 110 below and a plurality of second apparatuses performing similar operations as described with respect to the second apparatus 120 below.

The second apparatus 120 transmits (205) a DCI message prior to scheduling a Msg4 transmission towards the first apparatus 110 on a scheduled PDSCH. Accordingly, the first apparatus 110 receives (210) the DCI message from the second apparatus 120. The DCI message includes at least one reserved bit reused in association with an indication of a repetition factor that is used to transmit at least one HARQ-ACK for the scheduled Msg4 transmission.

After transmitting (205) the DCI message, the second apparatus 120 performs (215) the scheduled Msg4 transmission towards the first apparatus 110 during a random access procedure. Accordingly, the first apparatus 110 receives (220) the scheduled Msg4 transmission from the second apparatus 120 on a scheduled PDSCH for performing the random access procedure.

After receiving the scheduled Msg4, the first apparatus 110 may further transmit (225) at least one HARQ-ACK for the scheduled Msg4 transmission via a PUCCH towards the second apparatus 120. Accordingly, the second apparatus 120 may receive (230) the at least one HARQ-ACK from the first apparatus 110.

In some example embodiments, the reserved bits in DCI 1_0 with CRC scrambled by TC-RNTI may be re-purposed to carry PUCCH Repetition factor for Msg4 HARQ-ACK. Alternatively, the reserved bits may be re-purposed to extend the usage of the reserved bits currently present in the DCI 1_0 as a fallback (or replacement bits as referred to in this application) in the case that a new field for PUCCH repetitions is introduced in the DCI 1_0 with CRC scrambled by TC-RNTI but the field is not present in a specific instance of the DCI 1_0 with CRC scrambled by TC-RNTI due to, for example, UE not supporting the capability of PUCCH repetitions for Msg4 HARQ-ACK or to only one repetition factor being configured for PUCCH repetitions or to no repetition factor being configured for PUCCH repetitions. Indeed, for example in the case no repetition factor is configured, the UE may be expected to transmit the HARQ-ACK without repetitions, so that no bits would be assigned to the newly introduced field for dynamic indication of PUCCH repetition. In such a case, to keep the DCI size constant, which is important to respect the DCI size alignment rules as defined in TS 38.212, replacement bits (replacing the absent bits of the newly introduced field for dynamic indication of PUCCH repetition) are necessary, which is the target of the present disclosure. According to some example embodiments of the present disclosure, the operation of the currently present reserved bits may be extended, which may be descried in detail below.

In some example embodiments, the at least one reserved bit may be reused to indicate a repetition factor that is used to transmit the at least one HARQ-ACK in response to the scheduled Msg4 transmission. In some example embodiments, the first apparatus 110, which may operate as a user device, may receive, from the second apparatus 120, which may operate as the network element, a configuration for a plurality of repetition factors available for the at least one HARQ-ACK for the scheduled Msg4 transmission. In this example, the indicated repetition factor may be selected from the plurality of repetition factors.

In an example, the purpose of the reserved bits may be extended to carry the codepoint to the values of the PUCCH repetition factors, in a case that multiple values of the repetition factors are configured and UE supports the capability for PUCCH repetitions. In the case that only one repetition factor is configured, or the repetition factor is not configured via higher layers, the reserved bits may be mandated to either be ignored, or to match the configured repetition factor, or to provide an acknowledgment to UE on whether to use the configured one repetition factor. Alternatively, in such a scenario, no reserved bits may be present, and a field size of the reserved bits may be equal to 0 bits. Furthermore, in the case that multiple values of the repetition factors are configured but UE does not support the capability of PUCCH repetitions, the reserved bits may be mandated to be set to 0 or no reserved bits may be present.

In some example embodiments, the repetition factor may be indicated via a field in the DCI message, wherein the at least one reserved bit may be extended to function as fallback bit(s) when the field is not present in the DCI message.

In some example embodiments, the field in the DCI message may not be present if no repetition factor is configured; if one repetition factors is configured for the at least one HARQ-ACK for the scheduled Msg4 transmission; in the case of no capability of the apparatus to support repetitions for the at least one HARQ-ACK for the scheduled Msg4 transmission.

In an example, the purpose of the reserved bits may be extended to function as fallback bits to be used in a case that a new field for PUCCH repetitions is introduced but the field is not present for a specific instance of the DCI 1_0 scrambled with TC-RNTI. The new field could not be present for example in one of the following cases: the PUCCH repetition factors are not configured, or only one repetition factor is configured, or UE does not support the PUCCH repetition capability. This example embodiment may be described in detail hereinafter.

In some example embodiments, the first apparatus 110, which may operate as a user device, may transmit, to the second apparatus 120, which may operate as the network element, an indication of a preferred repetition factor that is used to transmit the at least one HARQ-ACK for the scheduled Msg4 transmission. In this example, the at least one reserved bit may be reused to indicate whether the preferred repetition factor is applied or not. In some example embodiments, the second apparatus 120 may determine that the at least one reserved bit indicates that the preferred repetition factor is unapplied. Then, the first apparatus 110 may transmit, to the network element, the HARQ-ACK for the scheduled Msg4 transmission with no repetition or a predetermined number of repetitions.

In an example, the UE may be able to indicate a preference for a given (e.g., pre-configured) repetition factor from a larger set. By way of example rather than limitation the set may include 1, 2, 4, and 8. In this case, the UE may indicate one of the values in the set towards the gNB. The gNB may use a single reserved bit of the DCI 1_0 to represent an “acknowledgement” of the UE preference. In this case, if a UE indicates preference for repetition factor 4, the gNB may trigger repetitions by the UE by setting the value to “1”, while a value of “0” may mean “no repetitions to be used”. Alternatively, in case that UE indicated repetition may co-exist with gNB decided repetition, the Table 2 shown in below can be updated to be compatible, which means also use 2-bits.

In some example embodiments, the at least one reserved bit may be reused to indicate whether at least one field in the DCI message is reused to indicate a repetition factor that is used to transmit the at least one HARQ-ACK for the scheduled Msg4 transmission.

In an example, the purpose of the reserved bits may be extended to allow a UE to understand whether a field in the DCI 1_0 with CRC scrambled by TC-RNTI is repurposed or not. By way of example rather than limitation, the field may be one of the following fields: a MCS field, a PUCCH resource indicator field, an HARQ process number filed, a DAI field, a PDSCH-to-HARQ_feedback timing indicator field.

Based on the solutions according to some example embodiments of the present disclosure, no ambiguity is expected, and thus the above-mentioned PC issues are fixed.

For the purpose of illustration, a plurality of examples of higher layer configuration and physical layer signaling are listed below. Table 1 illustrates an example configuration of the PUCCH repetition indicator for Msg4 HARQ-ACK in pucch-ResourceCommon.

TABLE 1
Configuration of the PUCCH repetition indicator in pucch-ResourceCommon

| n-value | pucch-RepetitionNrofSlot-r18 |
|---|---|
| n1 | repetition factor 1 that may be configured via SIB |
| n2 | repetition factor 2 that may be configured via SIB |
| n4 | repetition factor 4 that may be configured via SIB |
| n8 | repetition factor 8 that may be configured via SIB |

Table 2 illustrates an example of the PUCCH repetition indicator for Msg4 HARQ-ACK in DCI of format 1_0 scrambled by TC-RNTI.

TABLE 2
PUCCH repetition indicator corresponding to the repetition
factor in pucch-RepetitionNrofSlot-r18

| Bit field | PUCCH repetition indicator |
|---|---|
| 00 | repetition factor 1 that may be configured via SIB (pucch-RepetitionNrofSlot-r18) |
| | or Not acknowledge the repetition preference of UE (in the above-men-tioned |
| | third example embodiment) |
| 01 | repetition factor 2 that may be configured via SIB(pucch-RepetitionNrofSlot-r18) |
| 10 | repetition factor 4 that may be configured via SIB(pucch-RepetitionNrofSlot-r18) |
| 11 | repetition factor 8 that may be configured via SIB(pucch-RepetitionNrofSlot-r18) |

Table 3 illustrates an example of the acknowledgement of UE reported preferred repetition factor.

TABLE 3
Acknowledgement of UE preferent repetition factor

| Bit field | Acknowledgement indicator |
|---|---|
| 0 | No acknowledgement |
| 1 | Acknowledgement |

Table 4 illustrates an example of the repurposing indicator for two bits of a field in DCI scheduling the Msg4 PDSCH.

TABLE 4
Repurposing indication with 2 bits

| Bit field | Repurposing indicator |
|---|---|
| 00 | Reserved |
| 01 | The MCS/DAI/HARQ process ID etc. is repurposed |
| 10 | No repurposing |
| 11 | Reserved |

Table 5 illustrates an example of the repurposing indicator for a single bit of a field in DCI scheduling the Msg4 PDSCH.

TABLE 5
Repurposing indication with 1 bit

| Bit field | Repurposing indicator |
|---|---|
| 0 | No repurposing |
| 1 | The MCS/DAI/HARQ process ID etc. is repurposed |

In some example embodiments, both ACK and NACK may apply repetition in order to exploit the gain of repetition combining.

Purpose extension of the reserved bits to indicate the PUCCH repetition factor for Msg4 HARQ feedback will be described in detail below.

In some example embodiments, in response to a PUSCH transmission scheduled by a random access response (RAR) UL grant when a UE has not been provided a C-RNTI, the UE may attempt to detect a DCI format 1_0 with CRC scrambled by a corresponding TC-RNTI scheduling a PDSCH that includes a UE contention resolution identity. The fields included in the DCI format 1_0 with CRC scrambled by a TC-RNTI are defined. In particular, the “ChannelAccess-CPext” feature, together with the reserved bits, occupies the last 2 bits.

In some example embodiments, ChannelAccess-CPext may include 2 bits indicating combinations of channel access type and cyclic prefix (CP) extension if channelAccessMode-r16=“semiStatic” is provided, for operation in a cell with shared spectrum channel access in frequency range 1. ChannelAccess-CPext may include 2 bits indicating channel access type if ChannelAccessMode2-r17 is provided for operation in a cell in frequency range 2-2. Otherwise, ChannelAccess-CPext may include 0 bit. Additionally, reserved bits field may include 2 bits when the DCI format is monitored in common search space for operation in a cell in frequency range 2-2 and the number of bits for the field of ‘ChannelAccess-CPext’ is 0. Otherwise, reserved bits field may include 0 bit.

In some example embodiments, NTN operation may be expected to be mutually exclusive with feature of “ChannelAccess-CPext” which may be used for operation in unlicensed band or frequency range 2-2. Based on this assumption, the description for the reserved bits could be updated for example as follows in the case a new field is introduced in the DCI 1_0 with CRC scrambled by TC-RNTI for indication of the PUCCH repetition factor (referred to as PUCCH repetition indicator) and the purpose of the reserved bits is expanded to being replacement bits in the case the bits of the new field are absent (e.g. because no repetition factor is configured). For example, PUCCH repetition indicator may include 2 bits when pucch-RepetitionNrofSlot-r18 present in SIB. Otherwise, PUCCH repetition indicator may include 0 bit. Reserved bits field may include 2 bits when the DCI format is monitored in common search space for operation in a cell in frequency range 2-2 and the number of bits for the field of ‘ChannelAccess-CPext’ is 0. Reserved bits field may include 2 bits when the DCI format is monitored in common search space for operation in a cell in a frequency range different than frequency range 2-2 and the number of bits for the field of ‘PUCCH repetition indicator’ is 0. Otherwise, reserved bits field may include 0 bit. In this case, reserved bits field is modified to account for the case the size of the field PUCCH repetition indicator is 0 bit.

In some example embodiments, in the case that no new field is introduced, the reserved bits are repurposed directly to indicate the PUCCH repetition factor from the configured Table pucch-RepetitionNrofSlot-r18, and the specification text could be updated, for example, as follows:
Reserved bits—2 bits when the DCI format is monitored in common search space for operation in a cell in frequency range 2-2 and the number of bits for the field of ‘ChannelAccess-CPext’ is 0; 2 bits when the DCI format is monitored in common search space for operation in a cell in a frequency range different than frequency range 2-2 and pucch-RepetitionNrofSlot-r18 is present in SIB; 0 bits otherwise

In some example embodiments, in the case that UE indicates a preference for a given pre-configured repetition factor to gNB, gNB may repurpose one of the reserved bits to indicate one entry of the configured Table 3, to indicate UE whether the preferred repetition factor is applied or not (the above-mentioned third example embodiment). gNB may transmit “0” to discard the preferred repetition factor. The preferred repetition factor may be indicated by UE via, for example, Msg3 signalling. In the case gNB transmits “0”, the UE may either perform no repetitions, or perform a fixed number of repetitions that may be higher layer configured or hardcoded in the specifications. Moreover, gNB may transmit “1” to acknowledge the repetition factor which is the preference of UE.

By way of example rather than limitation, the reserved bits may be updated as follows:
Reserved bits—2 bits when the DCI format is monitored in common search space for operation in a cell in frequency range 2-2 and the number of bits for the field of ‘ChannelAccess-CPext’ is 0; 1 bit when the DCI format is monitored in common search space for operation in a cell in a frequency range different than frequency range 2-2 and the field pucch-RepetitionNrofSlot-r18 is present in SIB; 0 bits otherwise

Alternatively, in case that UE indicated repetition can co-exist with gNB decided repetition, the Table 2 may be updated to be compatible which means also use 2-bits. In this case, the reserved bits could be updated as follows:
Reserved bits—2 bits when the DCI format is monitored in common search space for operation in a cell in frequency range 2-2 and the number of bits for the field of ‘ChannelAccess-CPext’ is 0; 2 bits when the DCI format is monitored in common search space for operation in a cell in a frequency range different than frequency range 2-2 and the table Acknowledgement indicator is present in SIB; 0 bits otherwise

In some example embodiments, in the case that the purpose of the reserved bits is extended for indication of whether the DCI field is repurposed or not (the above-mentioned fourth example embodiment) and Table 4 is configured. For example, gNB may transmit “01” to indicate the field in the DCI, i.e. MCS/DAI etc. is not repurposed because gNB detects the UE has no repetition capability. The Rel-18 UE with and without capability may interpret MCS/DAI with conventional way (not repurposed). The gNB may transmit “10” to indicate that the DCI, i.e. MCS/DAI is repurposed because gNB detects the UE has repetition capability. The UE with capability of PUCCH repetitions may decode the MCS/DAI with repurposed way and execute the repetition as indicated. The UE without capability of PUCCH repetitions won't send NACK as it understands the Msg4 is not for itself and promptly re-starts the RACH procedure without having to wait to the end of the contention resolution window.

It may be understood that the features ‘ChannelAccess-CPext’ and PUCCH repetitions are assumed to be mutually exclusive, as NTN is not expected to be operated in unlicensed band or in frequency range 2-2.

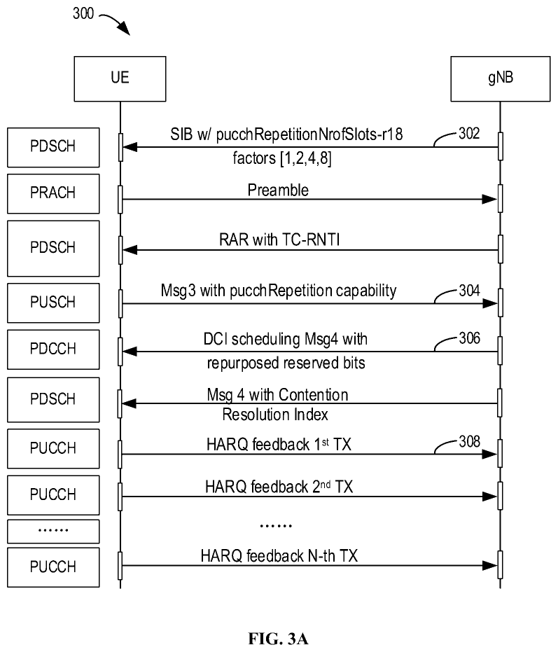

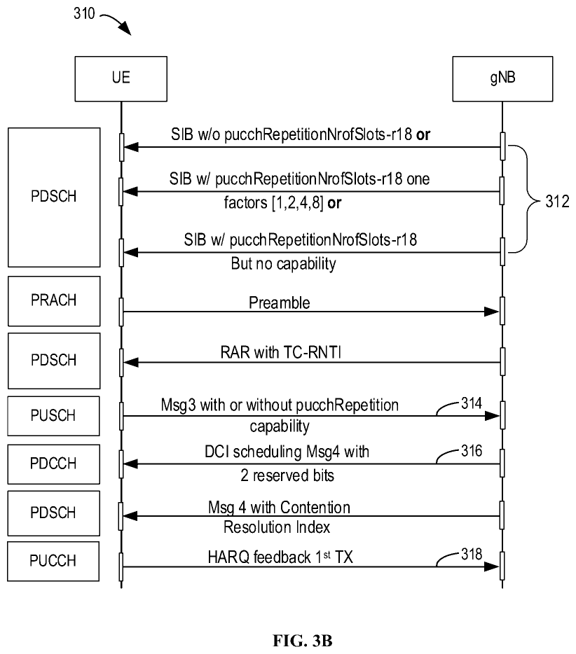

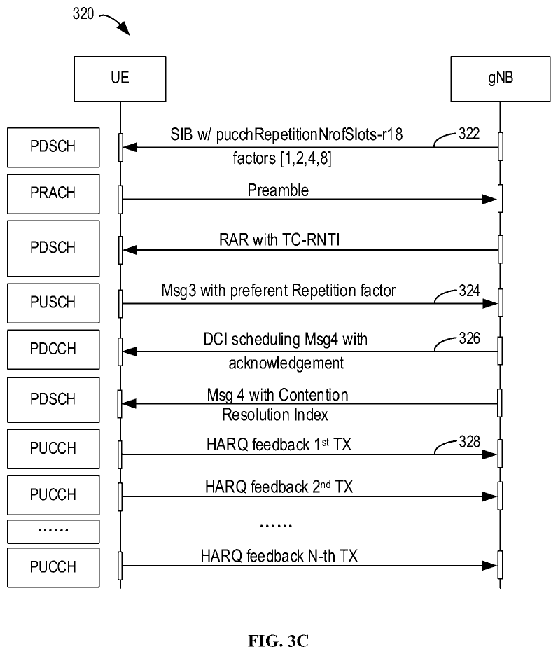

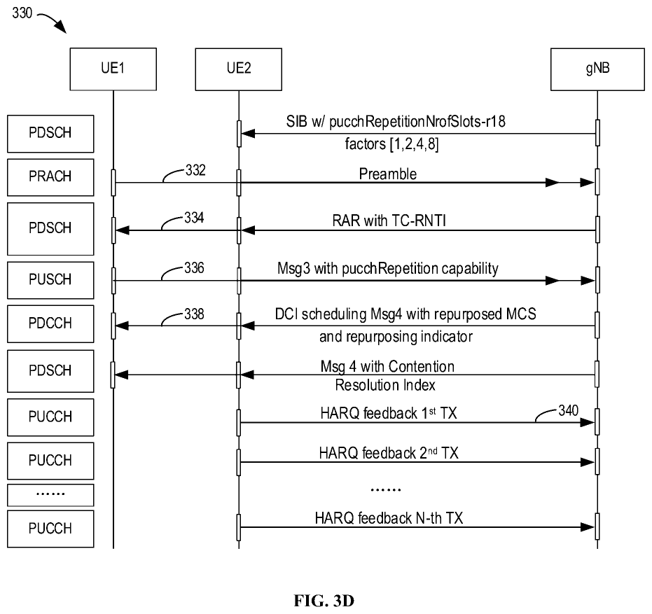

Some example processes of dynamic indications of repetitions for Msg4 will be discussed below with reference to FIGS. 3A to 3D. In these examples, the first apparatus 110 as shown in FIGS. 1 and 2 may operate as a UE, and the second apparatus 120 as shown in FIGS. 1 and 2 may operate as a gNB.

FIG. 3A illustrates a signaling diagram 300 of communications between a UE and a gNB according to some example embodiments of the present disclosure.

In the example embodiment shown in FIG. 3A, if the pucchRepetitionNrofSlots-r18 is present in SIB, denoted as 302 in FIG. 3A, the size of the field of PUCCH Repetition Indicator in DCI format 1_0 scrambled by TC-RNTI may be 2 bits. UE may indicate the capability of PUCCH repetition for Msg4 HARQ feedback in Msg3 scrambled by a TC-RNTI, denoted as 304 in FIG. 3A. After transmission of the Msg3, the UE may attempt to detect a DCI format 1_0 scrambled by the TC-RNTI where it carries the PUCCH repetition indicator (as described above) to indicate the repetition factor for the repetition capable UE, denoted as 306 in FIG. 3A, for the PUCCH repetition capable UE, the PUCCH repetition indicator i.e., is “00” corresponding repetition factor is “1” (only 1 PUCCH transmission), the UE can be indicated to transmit a PUCCH over

$${N}_{PUCCH}^{repeat}$$

slots, denoted as 308 in FIG. 3A, using PUCCH resource, where

$${N}_{PUCCH}^{repeat}$$

is provided by PUCCH repetition factor in Table 2.

FIG. 3B illustrates another signaling diagram 310 of communications between a UE and a gNB according to some example embodiments of the present disclosure.

In the example embodiment shown in FIG. 3B, in the case that the PUCCH repetition factors are not configured, or only one repetition factor is configured, or UE does not support the PUCCH repetition capability, denoted as 312 in FIG. 3B, the DCI scheduling Msg4 may sustain the 2-bits reserved for the constant DCI size, denoted as 316 in FIG. 3B, regardless of the capability of UE, denoted as 314 in FIG. 3B. If the PUCCH repetition factors are not configured, or UE does not support the PUCCH repetition capability, the UE shall not transmit PUCCH with repetition. If only one repetition factor is configured, the UE shall transmit PUCCH with configured repetition factor, denoted as 318 in FIG. 3B.

FIG. 3C illustrates a further signaling diagram 320 of communications between a UE and a gNB according to some example embodiments of the present disclosure.

In the example embodiment shown in FIG. 3C, UE may report the preferred repetition factor, e.g., in Msg3, denoted as 324 in FIG. 3C. The gNB may transmit DCI scheduling Msg4 with acknowledgement, for example by repurposing 1 or 2 bits of the reserved field, denoted as 326 in FIG. 3C, UE may transmit PUCCH repetition according to the preferred repetition factor if acknowledgment is received, denoted as 328 in FIG. 3C. If negative acknowledgment is received, UE may transmit either no repetitions or a fixed number of repetitions.

FIG. 3D illustrates a signaling diagram 330 of communications between a first UE, a second UE and a gNB according to some example embodiments of the present disclosure.

In the example embodiment shown in FIG. 3D, the first UE UE1 and the second UE UE2 are in the PC scenario. For instance, gNB may receive Msg3 of UE2 that is Rel-18 UE with repetition capability, then transmit DCI with repurposed MCS (as an example, even if any field in the DCI could be repurposed) and repurposing indicator, denoted as 338 in FIG. 3D, UE2 may transmit repetitious PUCCH according to repetition factor carried in DCI, denoted as 340 in FIG. 3D.

In view of the above, there is no ambiguity towards the PC scenario in the solutions according to some example embodiments of the present disclosure. In the first PC subcase (non-repurposed field of reserved bits), even UEs with PUCCH repetition capability will be able to correctly interpret the DCI (as the reserved bits will just be set to 0), decode the Msg4 and promptly re-start the RACH procedure without having to wait to the end of the contention resolution window and without transmitting “NACK” with repetitions occupying resources not assigned for the repetitions. In the second PC subcase (repurposed field of reserved bits), even UEs without PUCCH repetition capability will be able to decode the message (as they will ignore the content of the reserved bits field) and promptly re-start the RACH procedure without having to wait to the end of the contention resolution window and improve the RACH performance. The PC scenario often occurs in case high cell load that is not a corner case. On the contrary, the alternatives which re-purpose existing field cannot avoid such problems and lead to RACH performance degradation.

### Example Methods

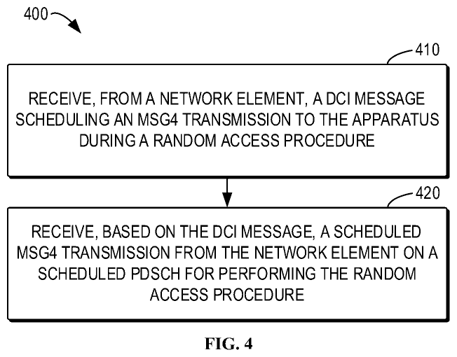

FIG. 4 shows a flowchart of an example method 400 implemented at a first apparatus in accordance with some example embodiments of the present disclosure. For the purpose of discussion, the method 400 will be described from the perspective of the first apparatus 110 in FIG. 1.

At block 410, the first apparatus 110 receives, from a network element, a DCI message scheduling an Msg4 transmission to the apparatus during a random access procedure.

At block 420, the first apparatus 110 receives, based on the DCI message, a scheduled Msg4 transmission from the network element on a scheduled PDSCH for performing the random access procedure. At least one reserved bit in the DCI message is reused in association with an indication of a repetition factor that is used to transmit at least one HARQ-ACK for the scheduled Msg4 transmission.

In some example embodiments, the at least one reserved bit may be reused to indicate a repetition factor that is used to transmit the at least one HARQ-ACK in response to the scheduled Msg4 transmission.

In some example embodiments, the first apparatus 110 may receive, from the network element, a configuration for a plurality of repetition factors available for the at least one HARQ-ACK for the scheduled Msg4 transmission. The indicated repetition factor may be selected from the plurality of repetition factors.

In some example embodiments, the first apparatus 110 may transmit, to the network element, an indication of a preferred repetition factor that is used to transmit the at least one HARQ-ACK for the scheduled Msg4 transmission. The at least one reserved bit may be reused to indicate whether the preferred repetition factor is applied or not.

In some example embodiments, based on a determination that the at least one reserved bit indicates that the preferred repetition factor is unapplied, the first apparatus 110 may transmit, to the network element, the HARQ-ACK for the scheduled Msg4 transmission with no repetition or a predetermined number of repetitions.

In some example embodiments, the at least one reserved bit may be reused to indicate whether at least one field in the DCI message is reused to indicate a repetition factor that is used to transmit the at least one HARQ-ACK for the scheduled Msg4 transmission.

In some example embodiments, the first apparatus 110 may transmit, to the network element, an indication of a capability of supporting repetitions for the at least one HARQ-ACK for the scheduled Msg4 transmission. The at least one reserved bit may be reused based on the indicated capability.

In some example embodiments, the repetition factor may be indicated via a field in the DCI message, wherein the at least one reserved bit may be extended to function as fallback bit(s) when the field is not present in the DCI message.

In some example embodiments, the field in the DCI message may be not present in response to one or more of: no repetition factor being configured; one repetition factor being configured for the at least one HARQ-ACK for the scheduled Msg4 transmission; and no capability of the apparatus to support repetitions for the at least one HARQ-ACK for the scheduled Msg4 transmission.

In some example embodiments, the at least one HARQ-ACK for the scheduled Msg4 transmission may be transmitted via a Physical Uplink Control Channel (PUCCH).

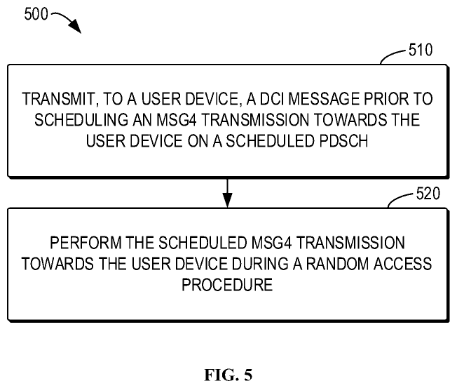

FIG. 5 shows a flowchart of an example method 500 implemented at a second apparatus in accordance with some example embodiments of the present disclosure. For the purpose of discussion, the method 500 will be described from the perspective of the second apparatus 120 in FIG. 1.

At block 510, the second apparatus 120 transmits, to a user device, a DCI message prior to scheduling an Msg4 transmission towards the user device on a scheduled PDSCH; and

At block 520, the second apparatus 120 performs the scheduled Msg4 transmission towards the user device during a random access procedure. At least one reserved bit in the DCI message is reused in association with an indication of a repetition factor to be used by the user device to transmit at least one HARQ-ACK for the scheduled Msg4 transmission.

In some example embodiments, the at least one reserved bit may be reused to indicate a repetition factor to be used to transmit the at least one HARQ-ACK in response to the scheduled Msg4 transmission.

In some example embodiments, the second apparatus 120 transmits, to the user device, a configuration for a plurality of repetition factors available for the at least one HARQ-ACK for the scheduled Msg4 transmission. The indicated repetition factor may be selected from the plurality of repetition factors.

In some example embodiments, the second apparatus 120 may receive, from the user device, an indication of a preferred repetition factor for transmitting the at least one HARQ-ACK for the scheduled Msg4 transmission. The at least one reserved bit may be reused to indicate whether the preferred repetition factor is applied or not.

In some example embodiments, the at least one reserved bit indicates that the preferred repetition factor is unapplied. The second apparatus 120 may receive, from the user device, the at least one HARQ-ACK for the scheduled Msg4 transmission with no repetition or a predetermined number of repetitions.

In some example embodiments, the at least one reserved bit may be reused to indicate whether at least one field in the DCI message is reused to indicate a repetition factor to be used by the further apparatus to transmit the at least one HARQ-ACK for the scheduled Msg4 transmission.

In some example embodiments, the second apparatus 120 may receive, from the user device, an indication of a capability of the user device to support repetitions for the at least one HARQ-ACK for the scheduled Msg4 transmission. The at least one reserved bit may be reused based on the indicated capability.

In some example embodiments, the repetition factor may be indicated via a field in the DCI message, wherein the at least one reserved bit may be extended to function as fallback bit(s) when the field not being present in the DCI message.

In some example embodiments, the field in the DCI message may be not present in response to one or more of: no repetition factor being configured; one repetition factor being configured for the at least one HARQ-ACK; and a capability of the apparatus to support repetitions for the at least one HARQ-ACK.

In some example embodiments, the HARQ-ACK of the scheduled Msg4 transmission may be received via a Physical Uplink Control Channel (PUCCH).

### Example Apparatus, Device and Medium

In some example embodiments, a first apparatus capable of performing any of the method 400 (for example, the first apparatus 110 in FIG. 1) may include means for performing the respective operations of the method 400. The means may be implemented in any suitable form. For example, the means may be implemented in a circuitry or software module. The first apparatus may be implemented as or included in the first apparatus 110 in FIG. 1.

In some example embodiments, the first apparatus includes means for receiving, from a network element, a Downlink Control Information (DCI) message scheduling a Message 4 (Msg4) transmission to the first apparatus during a random access procedure; and means for receiving, based on the DCI message, a scheduled Msg4 transmission from the network element on a scheduled Physical Downlink Shared Channel (PDSCH) for performing the random access procedure, wherein at least one reserved bit in the DCI message is reused in association with an indication of a repetition factor that is used to transmit at least one Hybrid Automatic Repeat Request Acknowledgement (HARQ-ACK) for the scheduled Msg4 transmission.

In some example embodiments, the at least one reserved bit is reused to indicate a repetition factor that is used to transmit the at least one HARQ-ACK in response to the scheduled Msg4 transmission.

In some example embodiments, the first apparatus includes: means for receiving, from the network element, a configuration for a plurality of repetition factors available for the at least one HARQ-ACK for the scheduled Msg4 transmission, wherein the indicated repetition factor is selected from the plurality of repetition factors.

In some example embodiments, the first apparatus includes: means for transmitting, to the network element, an indication of a preferred repetition factor that is used to transmit the at least one HARQ-ACK for the scheduled Msg4 transmission, wherein the at least one reserved bit is reused to indicate whether the preferred repetition factor is applied or not.

In some example embodiments, the first apparatus includes: means for based on a determination that the at least one reserved bit indicates that the preferred repetition factor is unapplied, transmitting, to the network element, the HARQ-ACK for the scheduled Msg4 transmission with no repetition or a predetermined number of repetitions.

In some example embodiments, the at least one reserved bit is reused to indicate whether at least one field in the DCI message is reused to indicate a repetition factor that is used to transmit the at least one HARQ-ACK for the scheduled Msg4 transmission.

In some example embodiments, the first apparatus includes: means for transmitting, to the network element, an indication of a capability of supporting repetitions for the at least one HARQ-ACK for the scheduled Msg4 transmission, wherein the at least one reserved bit is reused based on the indicated capability.

In some example embodiments, the repetition factor may be indicated via a field in the DCI message, wherein the at least one reserved bit may be extended to function as fallback bit(s) when the field is not present in the DCI message.

In some example embodiments, the field in the DCI message is not present in response to one or more of: no repetition factor being configured; one repetition factor being configured for the at least one HARQ-ACK for the scheduled Msg4 transmission; no capability of the first apparatus to support repetitions for the at least one HARQ-ACK for the scheduled Msg4 transmission.

In some example embodiments, the at least one HARQ-ACK for the scheduled Msg4 transmission is transmitted via a Physical Uplink Control Channel (PUCCH).

In some example embodiments, the first apparatus further includes means for performing other operations in some example embodiments of the method 400 or the first apparatus 110. In some example embodiments, the means includes at least one processor; and at least one memory storing instructions that, when executed by the at least one processor, cause the performance of the first apparatus.

In some example embodiments, a second apparatus capable of performing any of the method 500 (for example, the second apparatus 120 in FIG. 1) may include means for performing the respective operations of the method 500. The means may be implemented in any suitable form. For example, the means may be implemented in a circuitry or software module. The second apparatus may be implemented as or included in the second apparatus 120 in FIG. 1.

In some example embodiments, the second apparatus includes means for transmitting, to a user device, a Downlink Control Information (DCI) message prior to scheduling a Message 4 (Msg4) transmission towards the user device on a scheduled Physical Downlink Shared Channel (PDSCH); and perform the scheduled Msg4 transmission towards the user device during a random access procedure, wherein at least one reserved bit in the DCI message is reused in association with an indication of a repetition factor to be used by the user device to transmit at least one Hybrid Automatic Repeat Request Acknowledgement (HARQ-ACK) for the scheduled Msg4 transmission.

In some example embodiments, the at least one reserved bit is reused to indicate a repetition factor to be used to transmit the at least one HARQ-ACK in response to the scheduled Msg4 transmission.

In some example embodiments, the second apparatus includes: means for transmitting, to the user device, a configuration for a plurality of repetition factors available for the at least one HARQ-ACK for the scheduled Msg4 transmission, wherein the indicated repetition factor is selected from the plurality of repetition factors.

In some example embodiments, the second apparatus includes: means for receiving, from the user device, an indication of a preferred repetition factor for transmitting the at least one HARQ-ACK for the scheduled Msg4 transmission, wherein the at least one reserved bit is reused to indicate whether the preferred repetition factor is applied or not.

In some example embodiments, the at least one reserved bit indicates that the preferred repetition factor is unapplied, and the at least one memory and the second apparatus includes: means for receiving, from the user device, the at least one HARQ-ACK for the scheduled Msg4 transmission with no repetition or a predetermined number of repetitions.

In some example embodiments, the at least one reserved bit is reused to indicate whether at least one field in the DCI message is reused to indicate a repetition factor to be used by the further second apparatus to transmit the at least one HARQ-ACK for the scheduled Msg4 transmission.

In some example embodiments, the second apparatus includes: means for receiving, from the user device, an indication of a capability of the user device to support repetitions for the at least one HARQ-ACK for the scheduled Msg4 transmission, wherein the at least one reserved bit is reused based on the indicated capability.

In some example embodiments, the repetition factor may be indicated via a field in the DCI message, when the at least one reserved bit may be extended to function as fallback bit(s) when the field is not present in the DCI message.

In some example embodiments, the field in the DCI message is not present in response to one or more of: no repetition factor being configured; one repetition factor being configured for the at least one HARQ-ACK; and no capability of the second apparatus to support repetitions for the at least one HARQ-ACK.

In some example embodiments, the HARQ-ACK of the scheduled Msg4 transmission is received via a Physical Uplink Control Channel (PUCCH).

In some example embodiments, the second apparatus further includes means for performing other operations in some example embodiments of the method 500 or the second apparatus 120. In some example embodiments, the means includes at least one processor; and at least one memory storing instructions that, when executed by the at least one processor, cause the performance of the second apparatus.

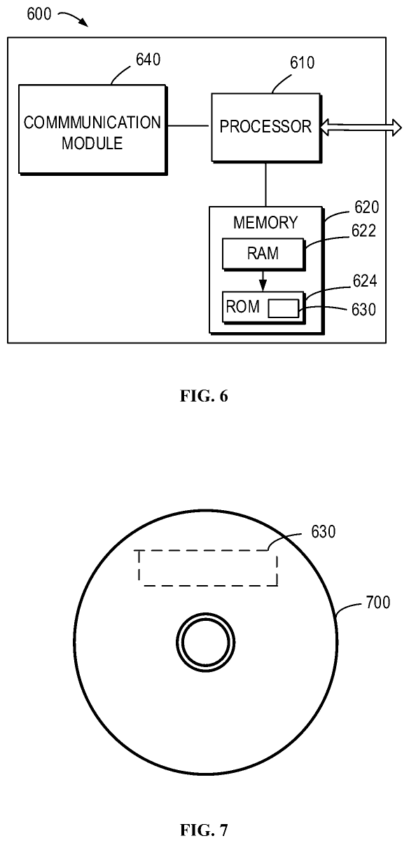

FIG. 6 is a simplified block diagram of a device 600 that is suitable for implementing example embodiments of the present disclosure. The device 600 may be provided to implement a communication device, for example, the first apparatus 110 or the second apparatus 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that may not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 1 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this may not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these may not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus comprising:
at least one processor; and
at least one memory storing instructions that, when executed by the at least one processor, cause the apparatus at least to:
receive, from a network element, a Downlink Control Information (DCI) message scheduling a Message 4 (Msg4) transmission to the apparatus during a random access procedure; and
receive, based on the DCI message, a scheduled Msg4 transmission from the network element on a scheduled Physical Downlink Shared Channel (PDSCH) for performing the random access procedure, wherein at least one reserved bit in the DCI message is reused in association with an indication of a repetition factor that is used to transmit at least one Hybrid Automatic Repeat Request Acknowledgement (HARQ-ACK) for the scheduled Msg4 transmission.

2. The apparatus of claim 1, wherein the at least one reserved bit is reused to indicate a repetition factor that is used to transmit the at least one HARQ-ACK in response to the scheduled Msg4 transmission.

3. The apparatus of claim 2, wherein the at least one memory and the at least one processor further cause the apparatus to:
receive, from the network element, a configuration for a plurality of repetition factors available for the at least one HARQ-ACK for the scheduled Msg4 transmission,
wherein the indicated repetition factor is selected from the plurality of repetition factors.

4. The apparatus of claim 1, wherein the at least one memory and the at least one processor further cause the apparatus to:
transmit, to the network element, an indication of a preferred repetition factor that is used to transmit the at least one HARQ-ACK for the scheduled Msg4 transmission,
wherein the at least one reserved bit is reused to indicate whether the preferred repetition factor is applied or not.

5. The apparatus of claim 4, wherein the at least one memory and the at least one processor further cause the apparatus to:
based on a determination that the at least one reserved bit indicates that the preferred repetition factor is unapplied, transmit, to the network element, the HARQ-ACK for the scheduled Msg4 transmission with no repetition or a predetermined number of repetitions.

6. The apparatus of claim 1, wherein the at least one reserved bit is reused to indicate whether at least one field in the DCI message is reused to indicate a repetition factor that is used to transmit the at least one HARQ-ACK for the scheduled Msg4 transmission.

7. The apparatus of claim 1, wherein the at least one memory and the at least one processor further cause the apparatus to:
transmit, to the network element, an indication of a capability of supporting repetitions for the at least one HARQ-ACK for the scheduled Msg4 transmission,
wherein the at least one reserved bit is reused based on the indicated capability.

8. The apparatus of claim 1, wherein the repetition factor is indicated via a field in the DCI message, wherein the at least one reserved bit is extended to function as one or more fallback bits when the field is not present in the DCI message.

9. The apparatus of any of claim 8, wherein the field in the DCI message is not present in response to one or more of:
no repetition factor being configured;
one repetition factor being configured for the at least one HARQ-ACK for the scheduled Msg4 transmission; and
no capability of the apparatus to support repetitions for the at least one HARQ-ACK for the scheduled Msg4 transmission.

10. The apparatus of claim 1, wherein the at least one HARQ-ACK for the scheduled Msg4 transmission is transmitted via a Physical Uplink Control Channel (PUCCH).

11. An apparatus comprising:
at least one processor; and
at least one memory storing instructions that, when executed by the at least one processor, cause the apparatus at least to:
transmit, to a user device, a Downlink Control Information (DCI) message prior to scheduling a Message 4 (Msg4) transmission towards the user device on a scheduled Physical Downlink Shared Channel (PDSCH); and
perform the scheduled Msg4 transmission towards the user device during a random access procedure, wherein at least one reserved bit in the DCI message is reused in association with an indication of a repetition factor to be used by the user device to transmit at least one Hybrid Automatic Repeat Request Acknowledgement (HARQ-ACK) for the scheduled Msg4 transmission.

12. The apparatus of claim 11, wherein the at least one reserved bit is reused to indicate a repetition factor to be used to transmit the at least one HARQ-ACK in response to the scheduled Msg4 transmission.

13. The apparatus of claim 12, wherein the at least one memory and the at least one processor further cause the apparatus to:
transmit, to the user device, a configuration for a plurality of repetition factors available for the at least one HARQ-ACK for the scheduled Msg4 transmission,
wherein the indicated repetition factor is selected from the plurality of repetition factors.

14. The apparatus of claim 11, wherein the at least one memory and the at least one processor further cause the apparatus to:
receive, from the user device, an indication of a preferred repetition factor for transmitting the at least one HARQ-ACK for the scheduled Msg4 transmission,
wherein the at least one reserved bit is reused to indicate whether the preferred repetition factor is applied or not.

15. The apparatus of claim 14, wherein the at least one reserved bit indicates that the preferred repetition factor is unapplied, and the at least one memory and the at least one processor further cause the apparatus to:
receive, from the user device, the at least one HARQ-ACK for the scheduled Msg4 transmission with no repetition or a predetermined number of repetitions.

16. The apparatus of claim 11, wherein the at least one reserved bit is reused to indicate whether at least one field in the DCI message is reused to indicate a repetition factor to be used by the further apparatus to transmit the at least one HARQ-ACK for the scheduled Msg4 transmission.

17. The apparatus of claim 11, wherein the at least one memory and the at least one processor further cause the apparatus to:
receive, from the user device, an indication of a capability of the user device to support repetitions for the at least one HARQ-ACK for the scheduled Msg4 transmission,
wherein the at least one reserved bit is reused based on the indicated capability.

18. The apparatus of claim 11, wherein the repetition factor is indicated via a field in the DCI message, wherein the at least one reserved bit is extended to function as one or more fallback bits when the field is not present in the DCI message.

19. The apparatus of claim 18, wherein the field in the DCI message is not present in response to one or more of:
no repetition factor being configured;
one repetition factor being configured for the at least one HARQ-ACK; and
no capability of the apparatus to support repetitions for the at least one HARQ-ACK.

20. The apparatus of claim 11, wherein the HARQ-ACK of the scheduled Msg4 transmission is received via a Physical Uplink Control Channel (PUCCH).

21-61. (canceled)
